(19) United States
(12) Patent Application Publication
(10) Pub. No.: US 2007/0285532 A1
(43) Pub. Date: Dec. 13, 2007

(54) IMAGE-CAPTURING APPARATUS

(75) Inventor: Yasuhiro YAMAMOTO, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/751,837

(22) Filed: May 22, 2007

(30) Foreign Application Priority Data
May 25, 2006 (JP) 2006-144853

(51) Int. Cl. H04N 5/76

(52) U.S. Cl. 348/231.1

(57) ABSTRACT

An image-capturing apparatus is provided having a memory, a storage medium, and a storage control device. The memory is built in the image-capturing apparatus. The storage medium stores image data. The storage control device stores image data into the memory when the remainder of the storable capacity of said storage medium becomes too small to store image data.

### BACKGROUND OF THE INVENTION

1. Field of the Invention

The present invention relates to an image-capturing apparatus, in particular to the storage of an image file in a storage medium of the image-capturing apparatus.

2. Description of the Related Art

An image-capturing apparatus, for example a digital camera, converts a photography subject input from the lens to image data by utilizing a CCD/AFE. The image data is stored temporarily in a RAM, processed by a DSP, and then stored in a removable external storage medium. On an LCD screen, image data stored in the storage medium, a through image obtained through the lens, and information required for operating a digital camera are displayed either automatically or according to the operation of a switch.

The storage capacity of the storage medium that stores image data and is removable, for example an SD card™ is limited so that image data cannot be recorded exceeding its capacity. Therefore, the remainder of storable capacity will be diminished during the storing of image data. In this case, the process of storing image data cannot be completed, and the image data is lost. A digital camera which has a backup device located outside of the digital camera body to prevent loss of the image data is disclosed in Japanese Unexamined Patent Publication (KOKAI) No. 2004-153369.

However, the provision of a backup device external to the digital camera requires a transmitter, which increases the size and power consumption of the digital camera. Moreover, it does not assure the completion of data storage into the backup device because a communication failure may occur during transmission.

### SUMMARY OF THE INVENTION

An object of the present invention is to provide an image-capturing apparatus that can avoid the loss of image data in the event that the remainder of the storable capacity is diminished during the storing of image data.

According to the present invention, there is provided an image-capturing apparatus comprising a memory built in the image-capturing apparatus, a storage medium for storing image data, and a storage control device to enable storage of said image data to said memory when the remainder of storable capacity in the storage medium available for storing image data is diminishing.

### BRIEF DESCRIPTION OF THE DRAWINGS

The objects and advantages of the present invention will be better understood from the following description, with reference to the accompanying drawings in which:

FIG. 1 is a block diagram showing the image-capturing apparatus as an embodiment of the present invention;

FIG. 2 is a diagram showing how the memory is divided;

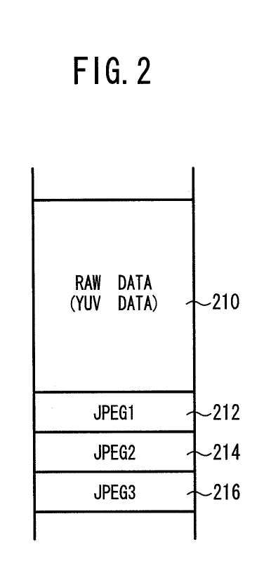

FIG. 3 is a flowchart showing the anterior half of the storing process of the present invention; and

FIG. 4 is a flowchart showing the posterior half of the storing process of the present invention;

### DESCRIPTION OF THE PREFERRED EMBODIMENTS

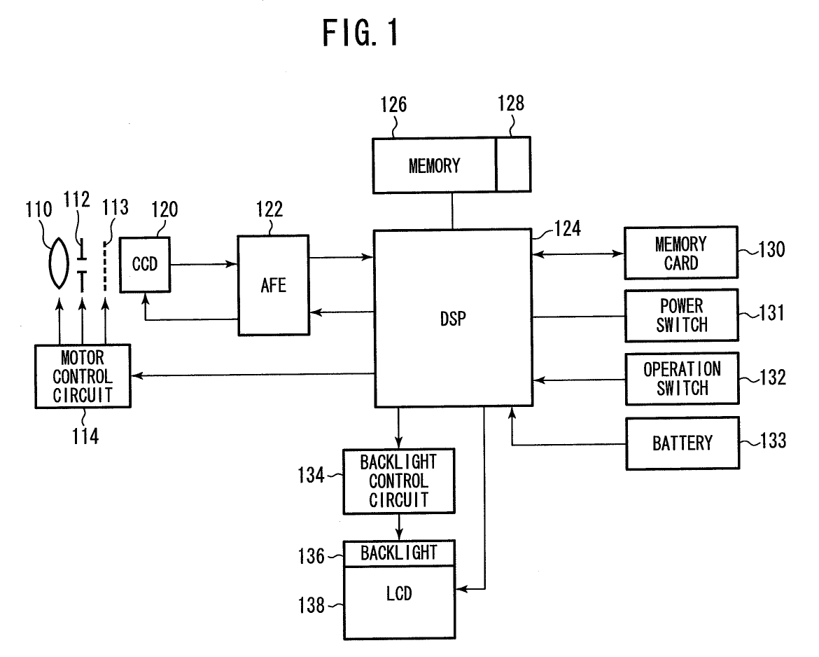

The present invention is described below with reference to the embodiments shown in the drawings. FIG. 1 is a block diagram showing a digital camera which has an image-capturing apparatus that applies to the embodiment of the present invention.

A photography subject is focused onto the CCD 120 through a lens 110, an aperture 112, and shutter 113. The lens 110, an aperture 112, and shutter 113 are controlled by a motor driving circuit 114 receiving instructions from a DSP 124. The shutter 113 is released by operating a release button (not shown), the CCD 120 converts a focused subject into an analog signal, and then an AFE 122 converts the analog signal received from the CCD 120 into a digital signal.

The DSP 124 compresses and stores a digital signal of the image data into a memory card 130 (e.g. SD card™) via temporarily storage of it into the memory 126. A battery 133 is connected to the DSP 124, to which it provides electric power. The DSP 124 controls the power supply or cutoff to devices provided in the digital camera, and controls the power supply to devices in power saving mode in order that the DSP 124 only provides power to a necessary minimum of devices, according to the operation of the power switch 131.

The image data is displayed on an LCD 138. The LCD 138 may display a still image or a moving image which is received from the AFE 122 before imaging, and may display image data stored in the memory card 130 after imaging. A backlight 136 is provided in the LCD 138. A backlight control circuit 134 turns the backlight 136 on when receiving an indication from the DSP 124.

The memory 126 comprises a DRAM with a refresh circuit 128. The refresh circuit 128 is a holding device for holding the image data in the memory 126, and a circuit to make the memory 126 operates in self-refresh-mode. In self-refresh-mode, the memory 126 performs the refresh operation automatically without a clock signal, i.e. a timing pulse provided from an external device. Therefore, the memory 126 can continue to hold a stored data, without a clock signal provided from an external device, with only electrical power provided. This makes it possible to lower the electrical consumption of the digital camera.

A working memory space 210 is provided in the memory 126 for storing pre-compressed image data, i.e. the raw data (YUV data) temporarily. Three backup spaces, i.e. a first backup space 212, a second backup space 214, and a third backup space 216, are provided for storing compressed image data in memory spaces other than the working memory space 210.

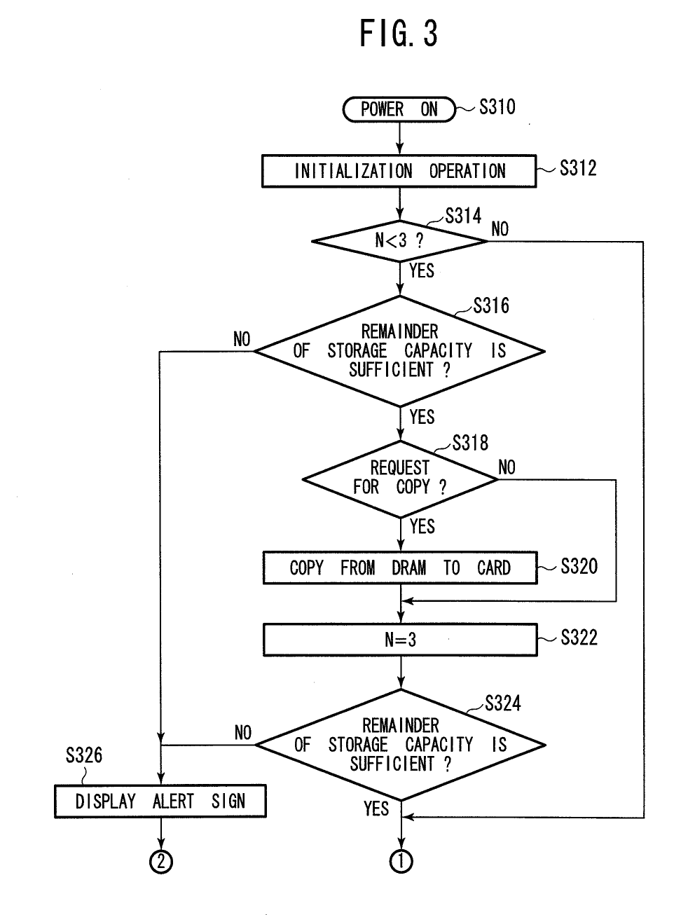

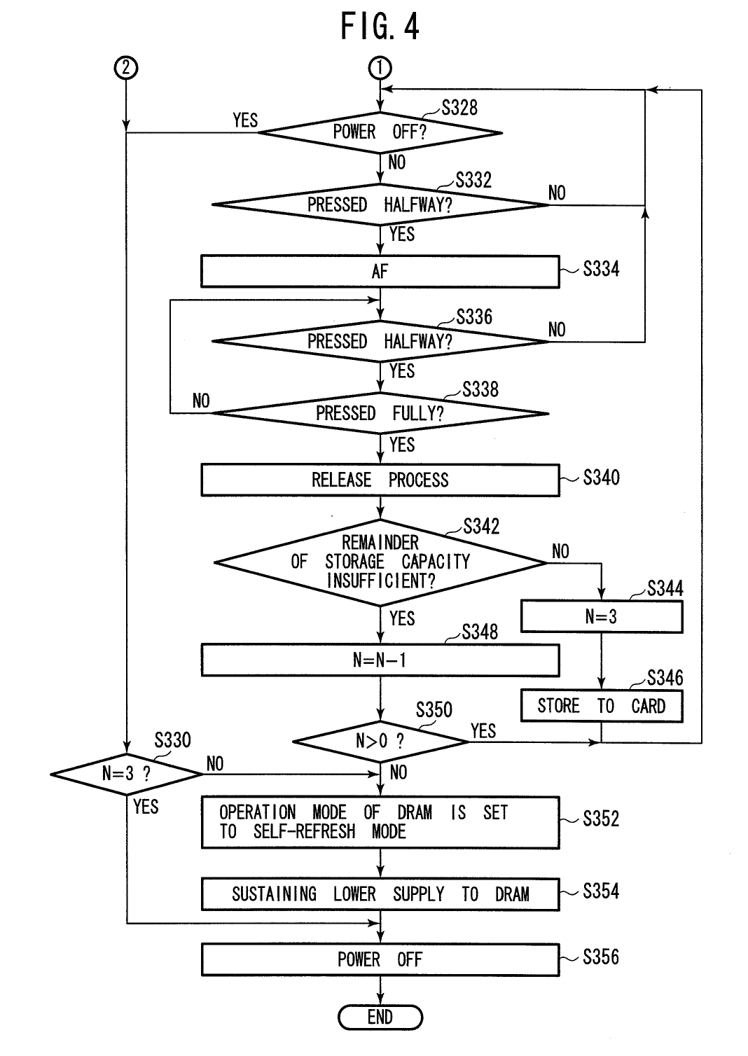

The embodiment of the invention is described below with references to FIGS. 3 and 4.

A digital camera is powered on in step S310, and then, executes an initialization operation in step S312. The initialization operation comprises the movement of the lens 110 into a photographing position and the display of a starting sign on the LCD 138. After the initialization, it is judged whether a counter N is less than 3 or not in step S314. The counter N indicates how much image data can be stored into the backup space of the memory 126. The memory 126 has three backup spaces in this embodiment, so the maximum number of the counter N is three. In the case that the counter N is greater than or equal to three, no image data has been stored in a backup space, so the process moves to step S328 without copying to the memory card 130.

When the counter N is less than three, it shows that the image data is stored in a backup space. A copy process whereby the image data is copied onto the memory card 130 from the memory 126, is therefore executed. It is judged whether the remainder of storable capacity in the memory card 130 is sufficient to store the image data or not in step S316. The judgment is carried out by comparing the size of the image data which is stored in the memory 126 with the remainder of storable capacity in the memory card 130. If the remainder is sufficient, a message is displayed on the LCD 138. This message enables the user to select whether the image data is copied onto the memory card 130 or not. Referring to the message, the user makes a choice between copying to the memory card 130 or not using an operation switch 132 in S318. When the option to not copy is chosen, the image data stored in the backup space is deleted, and the process moves to step S322. When the user chooses the option to copy, all the image data stored in the backup space is copied onto the memory card 130, and deleted from the backup space in step S320. All the image data stored in the backup space is now stored on the memory card, and all of the backup space is cleared, so that three spaces worth of image data can be stored in the backup space.

The numeral three is set into the counter N in step S322. The DSP 124 subsequently recognizes that three images can be stored in the backup space herewith.

It is judged whether the remainder of storable capacity in the memory card 130 is sufficient storage or not in step S324. If the remainder is not large enough, an alert sign, which indicates that the remainder is insufficient, is displayed on the LCD 138 in step S326. If the remainder is large enough, the process moves to step S328.

It is judged whether the power switch 131 is activated or not in step S328. If the power of the digital camera is switched off by operating the power switch 131, the process moves to step S330. When the power is not switched off, it is judged whether the release switch is pressed halfway or not in step S332. If the release switch is not pressed halfway, the process returns to step S328.

When the release switch is pressed halfway, auto-focusing (AF) is executed in step S334. It is judged whether the release switch is pressed halfway or not in step S336. If the release switch is pressed halfway, it is judged whether the release switch is pressed fully or not in step S338. When the release switch is pressed fully, a release process is executed in step S340. The release process generates image data by executing processes from imaging to image-compressing using devices including the lens 110 and the CCD 120. The image data is stored temporary into the working memory space 210 of the memory 126.

It is judged whether the remainder of storable capacity in the memory card 130 is sufficient for the storage of data or not in step S342. If the remainder is large enough, the numeral three is set into the counter N in step S344, and image data generated in step S340 is stored in the memory card 130. The photographing action is completed herewith, and the process returns to step S328.

If the remainder of storable capacity in the memory card 130 is not large enough for storage in step S342, the image data is stored into a backup space, and 1 is subtracted from the counter N. In the next step S350, it is judged whether counter N is greater than 0 or not. If the counter N is greater than 0, i.e. the backup space has some empty space, the process returns to step S328. If the counter N is less than or equal to 0, i.e. each backup space contains stored image data, the memory (DRAM) 126 is set to self-refresh-mode in step S352.

In self-refresh-mode, the power supply to the memory 126 is sustained in step S354, but the power of the digital camera is switched off in step S356. Thus, even if the power of a digital camera is off, the memory 126 and peripheral devices (not shown) are powered by the power supply (not shown) provided in the digital camera. In the case that the remainder of storable capacity in the memory card 130 is not large enough, it is enabled herewith that essential energy consumption of the digital camera is kept to a necessary minimum, and the image data remains in the a memory 126.

Note that the number of storage space for storing compressed image data may not only be limited to three, and may be greater than or equal to one.

The refresh circuit may not be disposed in the memory 128, but may also be disposed in the digital camera.

Moreover, the memory card is not limited to being an SD card™, but may also be a removable storage medium such as a Smart Media™, or a Compact Flash™.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2006-144853 (filed on May 25, 2006), which is expressly incorporated herein, by reference, in its entirety.

1. An image-capturing apparatus comprising:
a memory built in said image-capturing apparatus;
a storage medium for storing image data; and
a storage control device for storing said image data to said memory in the case that the remainder of storable capacity of said storage medium is running out during the storing of image data.

2. The image-capturing apparatus according to claim 1, wherein said memory comprises a holding device which keeps said image data stored in said memory when the power of said image-capturing apparatus is switched off.

3. The image-capturing apparatus according to claim 1, further comprising a holding device which keeps said image data stored in said memory when the power of said image-capturing apparatus is switched off.

4. The image-capturing apparatus according to claim 3, wherein said image data kept in said memory is stored into said storage medium after the power of said image-capturing device is switched on.

5. The image-capturing apparatus according to claim 4, wherein said image data kept in said memory is deleted from said memory after being stored into said storage medium.

6. The image-capturing apparatus according to claim 1, wherein said image data represents a picture, and said memory is able to store said image data that represents a number of pictures.

7. The image-capturing apparatus according to claim 1, wherein said memory is a volatile rewritable memory.

8. The image-capturing apparatus according to claim 1, wherein said storage medium is a removable memory card.

9. An image-capturing apparatus comprising:
a volatile memory built into said image-capturing apparatus;
a removable non-volatile memory for storing image data; and
a storage control device for storing said image data to said volatile memory in the case that said image data cannot be stored in said removable non-volatile memory, and for sustaining a power supply to said volatile memory in order to keep said image data stored in said volatile memory in the case that the power supply of said image-capturing apparatus is switched off.

10. The image-capturing apparatus according to claim 9, wherein said storage control device moves said image data stored in said volatile memory to said removable non-volatile memory in the case that said removable non-volatile memory is able to store said image data.
